(19) United States
(12) Patent Application Publication
(10) Pub. No.: US 2004/0261757 A1
(43) Pub. Date: Dec. 30, 2004

(54) Variable-volume rotary kinematic machine

(76) Inventors: Avraham Mordehay Nathan, Askelon (IL); Mario Avraham Nathan, Shoam (IL)

Correspondence Address: DR. MARK FRIEDMAN LTD., C/o Bill Polkinghorn, Discovery Dispatch, 9003 Florin Way, Upper Marlboro, MD, 20772, US

(21) Appl. No.: 10/608,182

(22) Filed: Jun. 30, 2003

(51) Int. Cl. F02B 53/00

(52) U.S. Cl. 123/241; 418/61.3

(57) ABSTRACT

Disclosed is a variable-volume rotary machine a principle of which is that the elements, which act as the rotary piston elements, themselves rotate about a secondary axis that passes through the piston element as they orbit about the primary axis of the machine. The operation volume of the present invention is a modified toroidal defined as the volume swept out by the piston elements as they simultaneously orbit the primary axis and rotate about the secondary axes. Described are two preferred embodiments of the present invention, one in which the piston elements rotate about an axis that is perpendicular to the axis of the toroid, and the other in which the piston elements rotate about an axis that is parallel to the axis of the toroid.

### FIELD AND BACKGROUND OF THE INVENTION

The present invention relates to rotary piston devices and, in particular, it concerns variable-volume rotary machine.

Devices are known in which an element rotating within a volume defined by a stator produces a desired effect. Notable among these are centrifugal pumps in which the vacuum created by a spinning rotor draws fluid in through an inlet and the blades of the rotor push it out through an outlet. In this type of rotary device, the angular relationship of the rotor element to the plane of rotation is unchanged through the path of rotation about the axis; therefore a cross-section through the axis of rotation taken at point will have the same contour.

Other variations that have been adapted for internal combustion engines include Wankel's eccentrically rotating triangular rotor and various devices utilizing toroidal cylinder volumes. Some disadvantages to the eccentrically rotating variations include vibrations due to unbalanced forces and movement of the rotor within the stator, and a low operational volume to stator volume ratio.

The toroidal design serves to answer the balance issue of the eccentric rotation variants. Typical of the toroidal variations, however, is the substantially unchanged angular relationship of the rotor element to the plane of rotation through the path of rotation about the axis of toroid, as mentioned above. One disadvantage of the toroidal variations is the apparent difficultly implementing a compression barrier as evidenced by the number of complex suggestions presented in the prior art.

There is therefore a need for a rotary machine with balanced rotational movements with an uncomplicated compression barrier. It would be beneficial if the rotary machine were to provide for embodiments that could be implemented as a compressor, a rotary motor, and a pump, both vacuum and hydraulic.

### SUMMARY OF THE INVENTION

The present invention is variable-volume rotary machine.

According to the teachings of the present invention there is provided, a rotary variable-volume machine comprising: (a) at least one piston element; (b) a piston mechanism configured to move the piston element in a motion that is simultaneous orbital motion about a primary axis and rotation about a secondary axis that passes through the piston element, such that the piston element sweeps out an annular path of variable cross-section; (c) a stator housing containing a modified toroidal operational volume, the modified toroidal operational volume defined by the annular path, such that the side piston element moves through the modified toroidal operational volume, the piston element contacting walls of the modified toroidal operational volume; (d) at least one inlet opening through the stator housing into the modified toroidal operational volume; and (e) at least one outlet opening through the stator housing from the modified toroidal operational volume.

According to a further teaching of the present invention the piston mechanism includes: (f) a main shaft deployed in the stator housing, the main shaft configured so as to rotate about the primary axis; and (g) at least one rotor mechanically linked to the main shaft so as to rotate about the primary axis of rotation, the rotor being at least partially deployed within the modified toroidal operational volume, the at least one piston element being deployed on the rotor.

According to a further teaching of the present invention the at least one piston element is implemented as at least one pair of piston elements deployed on the rotor, the piston elements having at least a region with a thickness substantially equal to the thickness of the rotor, and each one of the pair of the piston elements is deployed opposite another one of the pair at 180° and lies in a plane that is at 90° to a plane of another one of the pair, and at any point of rotation where any one of the piston elements lies within a cross-section of the rotor, a surface area of the stator housing contacts the rotor thereby creating a seal area.

According to a further teaching of the present invention the at least one inlet opening is configured proximally to the seal area in a direction of rotation, and the at least one outlet opening is configured distal to the seal area in a direction of rotation.

According to a further teaching of the present invention a ratio of piston rotation to rotor rotation is 1:2, therefore the at one inlet, the at least one outlet and the seal area is implemented as one inlet, one outlet and one seal area.

According to a further teaching of the present invention the secondary axis of rotation is perpendicular to the primary axis.

According to a further teaching of the present invention the rotor is implemented as a disc deployed on, and perpendicular to, the main shaft and at least partially deployed within the modified toroidal operational volume, the secondary axis lying in the rotor.

According to a further teaching of the present invention each of the pair of piston elements is attached to opposite ends of a rotatable axel lying on the secondary axis, rotation of the axel affected by interaction between a first gear affixed to the axel and second gear statically affixed to the stator housing, such that rotation of the main shaft causes rotation of the axel.

According to a further teaching of the present invention each the piston element is implemented substantially as a disc.

According to a further teaching of the present invention the secondary axis of rotation is implemented as at least a second and a third axes of rotation, both of which are parallel to the primary axis, such that each one of the pair of piston elements rotates about a corresponding one of the second and third axes of rotation.

According to a further teaching of the present invention the stator housing includes an inner and an outer stator element.

According to a further teaching of the present invention the rotor is implemented as a cylinder deployed within the modified toroidal operational volume, the cylinder configured so as to rotate about the inner stator element and the main shaft, the second and third axes lying substantially in the rotor.

According to a further teaching of the present invention each one of the pair of piston elements is attached to a corresponding rotatable axel, each corresponding axel therefore lying on one of the second and third axes of rotation, rotation of the axels affected by interaction between a first gear statically affixed to the stator housing and second and third gears each affixed to corresponding ones of the second and third axels, such that rotation of the main shaft causes rotation of the axels and the rotor.

According to a further teaching of the present invention each the piston element is implemented with a substantially rectangular outer contour.

According to a further teaching of the present invention the machine of the present invention is implemented as an internal combustion engine further comprising an injector for injecting a combustible mixture into the inlet.

According to a further teaching of the present invention the injector is a second such machine.

### BRIEF DESCRIPTION OF THE DRAWINGS

The invention is herein described, by way of example only, with reference to the accompanying drawings, wherein:

FIG. 1 is an exploded view of a first embodiment of a variable-volume rotary machine constructed and operable according to the teachings of the present invention;

FIG. 2 is a side cross-sectional view of the embodiment of FIG. 1;

FIG. 3 is a top cut-way view of two machines of FIG. 1, illustrating the interconnection of two such machine implemented as an internal combustion engine;

FIG. 4 is a cut-way side view of a second preferred embodiment constructed and operable according to the teachings of the present invention; and

FIG. 5 is an isometric view of the embodiment of FIG. 4.

### DESCRIPTION OF THE PREFERRED EMBODIMENTS

The present invention is variable-volume rotary machine.

The principles and operation of variable-volume rotary machine according to the present invention may be better understood with reference to the drawings and the accompanying description.

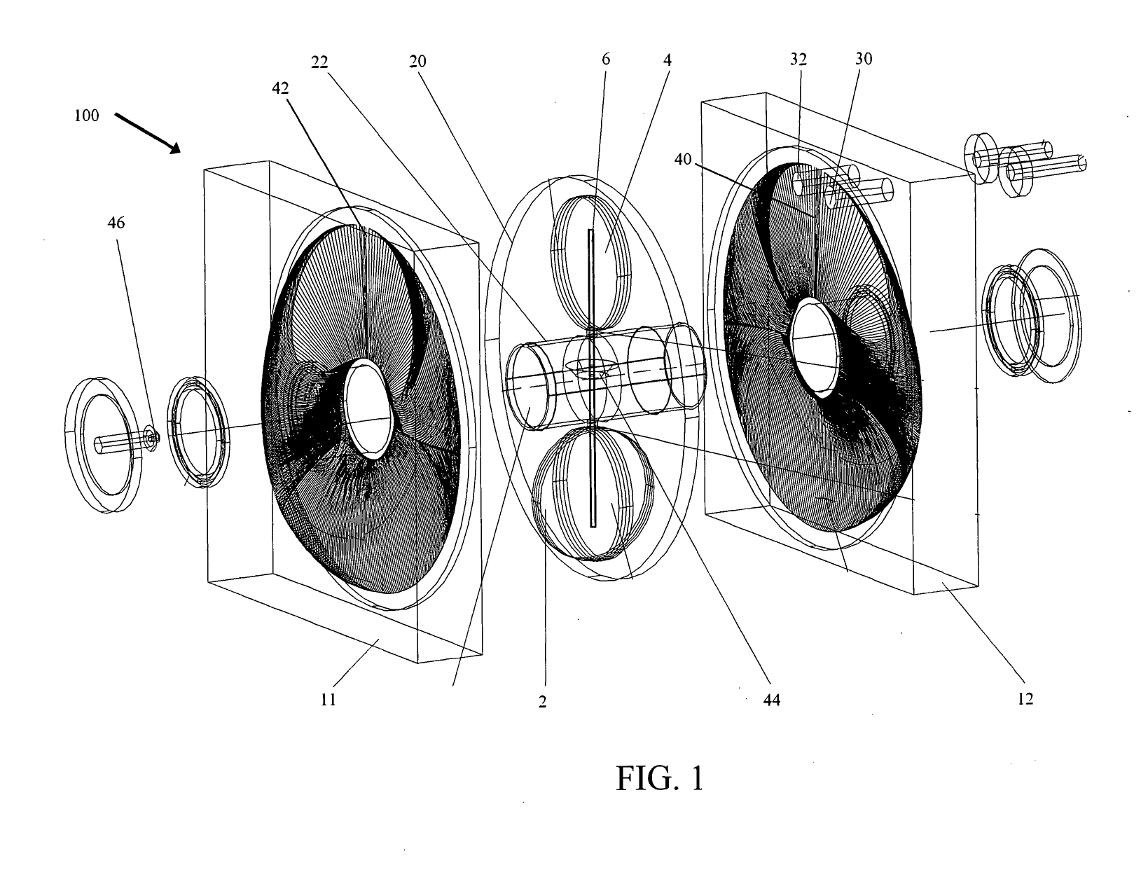

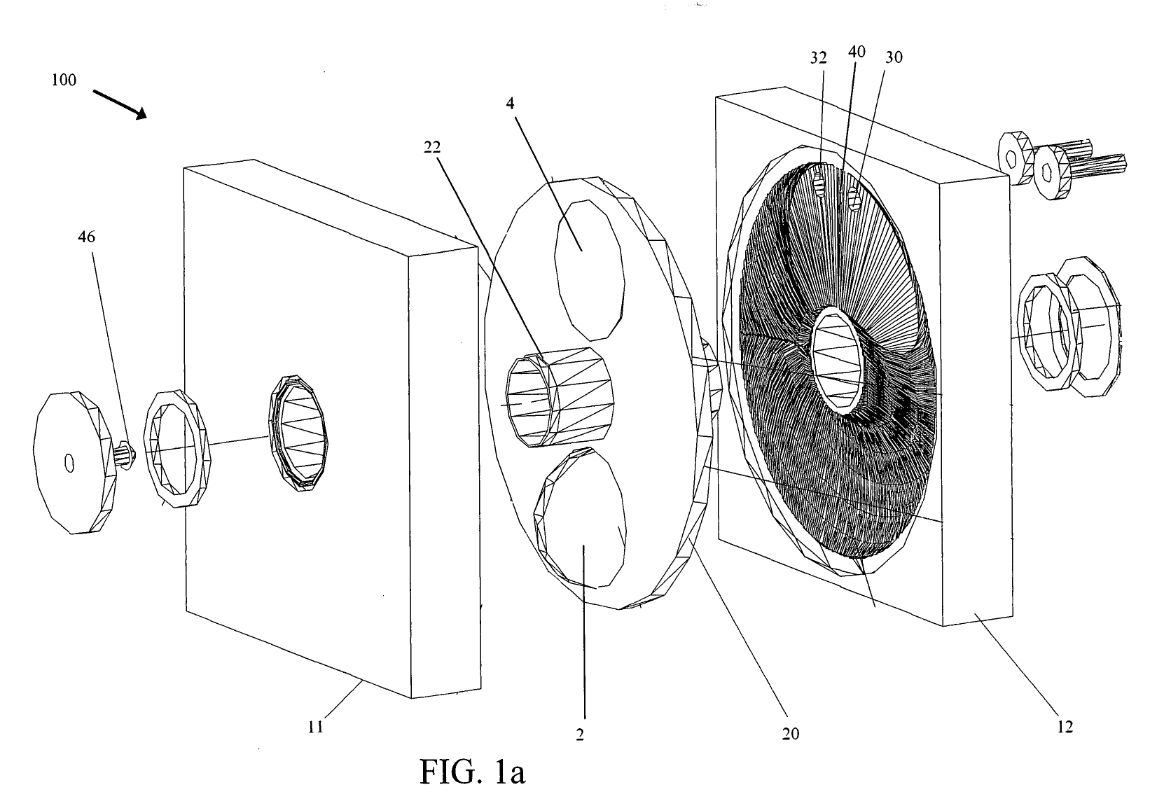

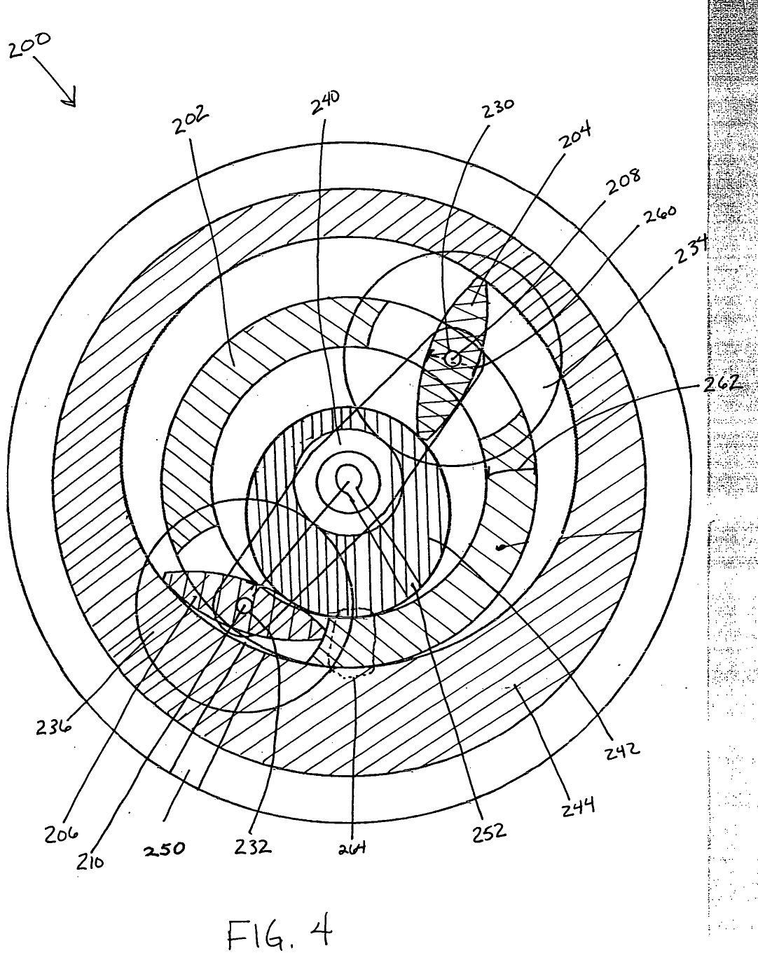

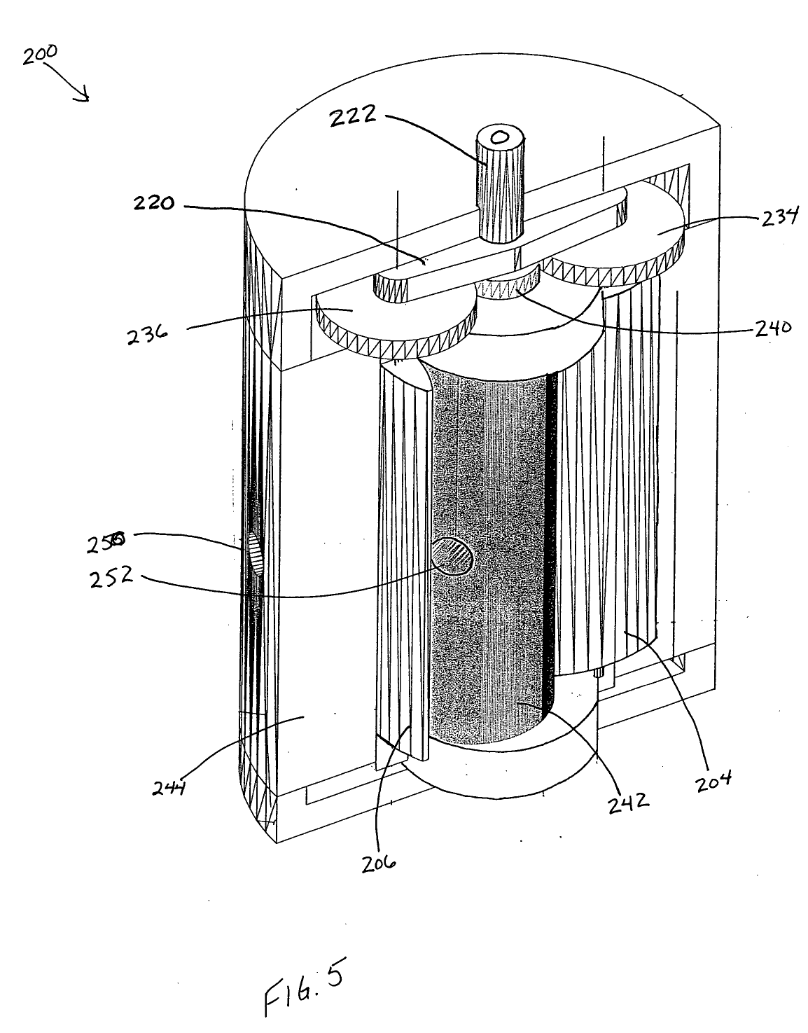

By way of introduction, a principle of the present invention is that the elements, which act as the rotary “pistons”, themselves rotate about a secondary axis that passes through the piston element as they orbit about the central axis of the machine. That is to say, as the piston elements travel through the toroidal volume of the machine, the piston elements rotate about an axis of rotation passing through the piston element other than the axis of the toroid. As used herein, the tern “piston elements” refers to a moving element that traps and pushes fluids toward a compression barrier. The term “fluids” is used herein to refer to any fluid whether is a gaseous or liquid state. The description herein will discuss two preferred embodiments of the present invention, one in which the piston elements rotate about an axis that is perpendicular to the axis of the toroid (FIGS. 1-3), and the other in which the piston elements rotate about an axis that is parallel to the axis of the toroid (FIGS. 4 and 5).

It should be noted that machines constructed and operational according to the principles of the present invention may be implement as any number of devices, such as, but not limited to, a compressor, a rotary motor, and pumps, both vacuum and hydraulic.

It will be readily understood that, due to the secondary rotation of the piston elements, the cross-sectional contour of the toroid must vary. That is, the volume swept out by the piston element during said substantially simultaneous rotation of said piston element about said first and second axes defines the modified toroidal volume.

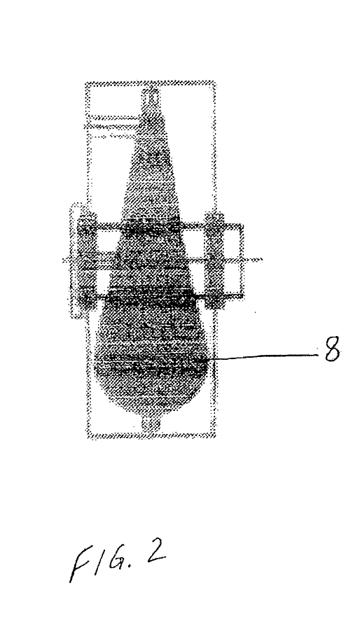

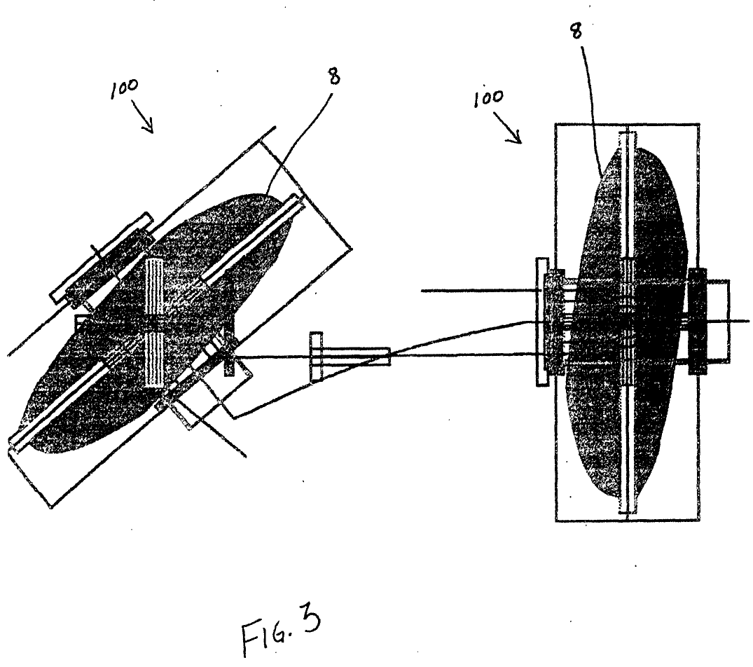

Referring now to the drawings, FIG. 1 illustrates a first preferred embodiment 100 of the present invention is which the piston elements 2 and 4 rotate about an axis that is perpendicular to the defining axis of the modified toroidal operating volume 8. A side view of the modified toroid 8 is illustrated in FIG. 2 and top view is illustrated in FIG. 3. The stator containing the modified toroidal operating volume of this embodiment of the present invention is configured as two opposing shell halves 10 and 12. Deployed within the toroidal operating volume 8, is a main rotor 20 mounted on a rotor shaft 22, which rotates about the primary axis, which defines the modified toroid. Mounted on the main rotor 20 are rotating piston elements 2 and 4 implemented here preferably as discs having a circular outer contour, however, the contour of substantially any plane closed curve, such as but not limited to squares, rectangles, ellipses, and parabolas, are within the scope of the present invention. It should be noted that the piston elements are preferably implemented in pairs and any number of pairs of piston elements may be deployed. Each one of the pair of piston elements is mounted on opposite ends of a common rotatable axel 6 that lies on the second axis of rotation. The axel 6 passes through the rotor shaft, and affixed to it is a conical drive gear 44, which in turn meshes with a static gear 46 that is fixedly attached to the stator housing. Therefore, as the main rotor rotates about the primary axis of rotation, the force of rotation causes the axel 6 to rotate about the second axis of rotation. It should be noted that common axel 6 may also be implemented as individual dedicated axels for each piston element. The embodiment illustrated here is that of a machine of the present invention with a static gear to drive gear ratio of 1:2. That is, the piston elements complete one half of a rotation for each one rotation of the rotor. Therefore there is one seal area and one inlet and one outlet. It is an intention of the present invention to also provide a machine with a gear ratio of 1:1. Therefore, such a machine will include two seal areas located at 180° from each other, and two sets of associated inlets and outlets.

The thickness of the piston elements is preferably is substantially equal, but may be less than, to the thickness of the rotor. Therefore, as illustrated by piston element 4, when the plane of the piston elements is parallel to the plane of the rotor, the piston element lies inside the contour of the rotor. There are therefore, areas 42 and 44 where the surfaces of the stator housings 11 and 12 contact the surface of the rotor and/or the piston, thereby creating a seal area or barrier through which any fluids held in the modified toroidal operational volume can not pass. Throughout the rotational path, the sides of the piston elements 2 and 4 are in contact with the walls of the stator closing the toroidal chamber. Thus a volume is defined by the seat area the walls of the toroidal chamber and a piston element. The first piston element passes through the seal area and into the open region of the toroidal chamber. At this point, fluid is then drawn in to the toroidal chamber through the inlet 30 as the volume between the piston element and the seal area increases as the piston element moves through the annular path of the toroidal chamber. As the second piston element passes the seal area the fluid that entered the toroidal chamber through the inlet 30 is now trapped between the two piston elements. As rotation continues, the first piston element passes through the seal area and the fluid is now trapped between the second piston element and the seat, which now acts as a compression barrier. As rotation continues, the fluid is pushed out though the outlet. It should be noted that in this first preferred embodiment the direction of rotation of the piston elements in relation to the rotor may be in either direction, clockwise or counter-clockwise.

The second preferred embodiment of the present invention, as illustrated in FIG. 4, applies the principles of the present invention to a machine 200 that has a cylindrical rotor 202, upon which are mounted the piston elements. Two piston elements 204 and 206 are discussed herein, however, the number of piston elements may be varied according to the requirements of a particular application. The piston elements 204 and 206 rotate about secondary axes 208 and 210 respectively. The piston elements are herein illustrated having a substantially rectangular contour; however as mention above, the contour of substantially any plane closed curve is within the scope of the present invention. The piston mechanism of this embodiment includes a piston element carriage 220 that is fixed to the main shaft 222, Affixed to the rotatable axels 230 and 232 are piston elements 204 and 206, respectively, and drive gears 234 and 236. A static gear 240 is fixed to the inner stator 242. Therefore, as the piston element carriage move the piston elements in an orbital motion about the primary axis of the main shaft, the interaction of the drives gears and the static gear affects secondary rotation of the piston elements.

The modified toroidal operation volume of this embodiment is defined as that volume swept out by the piston elements as they simultaneously orbit the primary axis and rotate about the secondary axes. Since the primary and secondary axes are parallel this embodiment of the present invention includes an inner stator 242 and an outer stator 244. It should be noted that while the orientation of the inner and outer stators to the primary axis is eccentric, these are non-moving parts, and all movement of the machine is circular and substantially balanced.

The cross-section of the piston elements of this embodiment includes an area at which the thickness 260 of the piston element is substantially equal to the thickness 262 of the rotor 202. Therefore, at area 264 the rotor is rotated to an orientation such that the piston element lies substantially inside the rotor. In this area both the inner and outer stators come in contact with the rotor, and/or piston element as it passes through the area, thereby creating a seal or barrier through which fluids are unable to pass.

As illustrated herein, the inlet is preferably located in the outer stator and the outlet in the inner stator. Location of the inlet and outlet may be varied, such as, but not limited to both located on the outer stator and both located on the inner stator.

An operational cycle of this embodiment would be as follows. Throughout the rotational path, the sides of the piston elements 204 and 206 are in contact with the walls of both the inner 242 and outer 244 stators closing the toroidal chamber. Thus a volume is defined by the seal area the walls of the inner 242 and outer 244 stators and a piston element. The first piston element passes through the seal area 264 and into the open region of the toroidal chamber. At this point, fluid is then drawn in to the toroidal chamber through the inlet 250 as the volume between the piston element and the seal area 264 increases as the piston element moves through the annular path of the toroidal chamber. As the second piston element passes the seal area 264, the fluid that entered the toroidal chamber through the inlet 250 is now trapped between the two piston elements. As rotation continues, the first piston element passes through the seal area 264 and the fluid is now trapped between the second piston element and the seat 264, which now acts as a compression barrier. As rotation continues, the fluid is pushed out though the outlet. It should be noted that in this second embodiment of the present invention, the direction of rotation of the piston elements is preferably in a direction opposite the direction of rotation of the rotor. That is, if the rotor is rotating in a clockwise direction, the piston elements preferably rotate in a counter-clockwise direction. However, implementation of piston elements that rotate in the same direction as the rotor is possible and within the spirit of the principles of the present invention. That is to say, while it may be preferable to implement this second embodiment of the present invention with piston elements that rotate in a direction opposite to the direction of rotation of the rotor, this embodiment may be implemented with piston elements that rotate in the same direction as the direction of rotation of the rotor. Either implementation would produces substantially equal results according to the principles of the present invention, however, the shape of the modified toroidal operational volume would be different.

The embodiment illustrated here is that of a machine of the present invention with a static gear to drive gear ratio of 1:2. That is, the piston elements complete one half of a rotation for each one rotation of the rotor. Therefore, there is one seal area and one inlet and one outlet. It is an intention of the present invention to also provide a machine with a gear ratio of 1:1. Therefore, such a machine will include two seal areas located at 180° from each other, and two sets of associated inlets and outlets. In such a machine, volume swept out by the rotation of the piston elements, as described above would be different as would be the cross-sectional contour of the inner and outer stators.

It should be noted that due to the complexity of the patterns of rotation of the piston elements created by the simultaneous rotation about two different axes as described above, the actual rotation of the piston in relation to the rotor may appear quite different when viewed from outside the machine. One classic example of this phenomenon is the Farris Wheel. The seats of a Farris Wheel appear not to rotate, in actuality the seat rotate in relation to the wheel at a ratio of 1:1 in a direction opposite to the direction of wheel rotation. Likewise, in this embodiment of the present invention, piston elements rotating in the opposite direction of the rotor at a ratio of 1:1 may appear not to rotate in relation to the stator.

It will be appreciated that, as illustrated in FIG. 3, two such machines 100 used in concert may be implemented as an internal combustion engine. As such, a first such machine performs the intake and compression strokes and a second such machine performs the combustion and exhaust stroke of the engine. Alternatively, any known injection device could be used with a single machine such that the injection device injects a pressurized combustible mixture into the inlet of the machine, which in turn performs the combustion and exhaust strokes of the engine. Although the illustration of FIG. 3 is that of the first preferred embodiment of the present invention, the principles of the present invention in the creation of an internal combustion engine apply equally to any embodiment of the present invention.

It will be appreciated that the above descriptions are intended only to serve as examples, and that many other embodiments are possible within the spirit and the scope of the present invention.

1. A rotary variable-volume machine comprising:
(a) at least one piston element;
(b) a piston mechanism configured to move said piston element in a motion that is simultaneous orbital motion about a primary axis and rotation about a secondary axis that passes through said piston element, such that said piston element sweeps out an annular path of variable cross-section, said piston mechanism including at least one rotor configured so as to rotate about said primary axis of rotation, said at least one piston element being deployed on said rotor;
(c) at least a first and a second stator portions housing containing between them a modified toroidal operational volume, said modified toroidal operational volume defined by said annular path, such that said at least one piston element moves through said modified toroidal operational volume, said piston element contacting walls of said modified toroidal operational volume;
(d) at least one inlet opening through said stator housing into said modified toroidal operational volume; and
(e) at least one outlet opening through said stator housing from said modified toroidal operational volume;
wherein said rotor is at least partially deployed within said modified toroidal operational volume said rotor and said at least one piston element passing between said at least first and second stator portions.

2. The rotary variable-volume machine of claim 1, wherein said piston mechanism includes:
(f) a main shaft deployed in said stator housing, said main shaft mechanically linked to said rotor and configured so as to rotate about said primary axis.

3. The rotary variable-volume machine of claim 2, wherein said at least one piston element is implemented as at least one pair of piston elements deployed on said rotor, said piston elements having at least a region with a thickness substantially equal to the thickness of said rotor, and each one of said pair of said piston elements is deployed opposite another one of said pair at 180° and lies in a plane that is at 90° to a plane of another one of said pair, and at any point of rotation where any one of said piston elements lies within a cross-section of said rotor, a surface area of said stator housing contacts said rotor thereby creating a seal area.

4. (canceled)

5. The rotary variable-volume machine of claim 2, wherein a ratio of piston rotation to rotor rotation is 1:2.

6. The rotary variable-volume machine of claim 2, wherein said secondary axis of rotation is perpendicular to said primary axis, and said at least a first and a second stator portions are implemented as two opposing stator housing shell halves.

7. The rotary variable-volume machine of claim 6, wherein said rotor is implemented as a disc deployed on, and perpendicular to, said main shaft and at least partially deployed within said modified toroidal operational volume, said secondary axis lying in said rotor.

8. The rotary variable-volume machine of claim 7, wherein said at least one piston elements is attached to an ends of a rotatable axle lying on said secondary axis, rotation of said axle affected by interaction between a first gear affixed to said axle and second gear statically affixed to said stator housing, such that rotation of said main shaft causes rotation of said axle.

9. The rotary variable-volume machine of claim 8, wherein each said piston element is implemented substantially as a disc.

10. The rotary variable-volume machine of claim 2, wherein said secondary axis of rotation is implemented as at least a second axis of rotation, which is parallel to said primary axis, such that said at least one piston elements rotates about said second axis of rotation.

11. The rotary variable-volume machine of claim 10, wherein said stator housing includes an inner and an outer stator element.

12. The rotary variable-volume machine of claim 11, wherein said rotor is implemented as a cylinder deployed within said modified toroidal operational volume, said cylinder configured so as to rotate about said inner stator element and said main shaft, said second axis lying substantially in said rotor.

13. The rotary variable-volume machine of claim 12, wherein said at least one piston elements is attached to a rotatable axle, said axle therefore lying on said second axis of rotation, rotation of said axle affected by interaction between a first gear statically affixed to said stator housing and at least a second gears affixed to said second axle, such that rotation of said main shaft causes rotation of said axle and said rotor.

14. The rotary variable-volume machine of claim 12, wherein said piston element is implemented with a substantially rectangular outer contour.

15. (canceled)

16. (canceled)

17. The rotary variable-volume machine of claim 10, wherein the direction of piston rotation is opposite to the direction of rotor rotation.
